(19) United States
(12) Patent Application Publication
(10) Pub. No.: US 2024/0278686 A1
(43) Pub. Date: Aug. 22, 2024

(54) TRAILER POWERPACK WITH RANGE EXTENDER

(71) Applicant: Fethi Rehouma, Verdun (CA)

(72) Inventor: Fethi Rehouma, Verdun (CA)

(21) Appl. No.: 18/570,803

(22) PCT Filed: Nov. 15, 2022
(86) PCT No.: PCT/CA2022/051684

§ 371 Date: Dec. 15, 2023

Related U.S. Application Data
(60) Provisional application No. 63/279,376, filed on Nov. 15, 2021.

(51) Int. Cl. B60L 58/12; B60L 50/75

(52) U.S. Cl. CPC B60L 58/12; B60L 50/75; B60L 2200/28; B60L 2210/10; B60L 2210/30

(57) ABSTRACT

An autonomous power supply for a vehicle includes a controller, a rechargeable battery: and a range extender. The controller, the rechargeable battery and the range extender are mounted on a vehicle trailer or a truck frame in a self-contained unit, and connected to an electric semi-truck. The range extender is adapted to charge the battery or to supply energy directly to the electric semi-truck or to an EV truck. The controller is in communication with the rechargeable battery and the range extender, the battery being charged to capacity in a default, stationary charging configuration, the battery is continually charged in a dynamic charging configuration.

### TECHNICAL FIELD

The present generally concerns transportation vehicles used with refrigeration units, and more particularly to trailer powerpacks with range extenders having a modular living space used with electric semi-trucks, diesel trucks and electric trucks.

### BACKGROUND

In the transportation industry, some of the products, such as perishable foodstuffs, or health products, must be transported in temperature-controlled vehicles, in order to maintain the cold chain. For that purpose, the vehicles generally include an isothermal truck body associated with a refrigeration unit which produces and maintains the necessary temperature. Usually, the refrigeration is carried out using a refrigeration unit installed on the front face or on the ceiling of the body of the isothermal truck body and powered by an internal combustion engine supplied with electricity through a generator powered by an internal combustion engine.

Truck bodies used for semi-trailers, with a typical length of from 31′ to 60′, include the refrigeration unit, and includes axles and specific brakes, with a kingpin used for coupling to a Semi-Truck to permit articulation. Straight trucks, on the other hand, include truck bodies, with a usual length from 14′ to 30′, which are installed on the chassis frame of a medium or heavy-duty truck.

Due to their design, refrigerated trailers are heavy to tow, consume large quantities of fuel and produce significant greenhouse gas emissions, both from the tractor and from the refrigeration unit installed on the trailer. Currently, many companies seek to reduce greenhouse gas emissions by using electric solutions while ensuring the best performance to maintain a constant temperature, reduce maintenance costs, and reduce fuel consumption.

In addition to refrigeration units, specialists in this field will easily recognize a significant problem for any road tractor manufacturer that limits the use of electric tractors over long distances. Limited space is a problem, and if additional space is needed for items such as batteries or hydrogen tanks, usable cab space is reduced. Furthermore, the extra space needed to install the batteries or hydrogen tanks significantly reduces the space available for drivers. Indeed, driver comfort and safety is therefore a current unmet need. Manufacturers have neglected these aspects in order to make trucking attractive.

There is therefore a clear need for a new road tractor design with an improved driver space. Also, there is a clear need for an energy efficient refrigeration unit that is self-powered and which reduces greenhouse gas emissions.

### BRIEF SUMMARY

We describe herein a self-contained power supply for the refrigeration unit for a vehicle, specifically a refrigerated trailer or a refrigerated body mounted on a truck. Specifically, we have designed a new and unobvious modular road tractor that significantly reduces, or essentially eliminates, the problems noted above. Indeed, our newly configured modular road tractor is designed so that it will no longer be affected by energy density (volume/weight, power). Our trailer powered electric semi-trucks provide spacious cabins for the drivers, while simultaneously providing sufficient autonomy for use over long distances. Our novel and unobvious vehicle houses the driver in very comfortable conditions while having greater autonomy because of the space provided by the trailers on which our power system stores large reserves of energy. The vehicle is equipped with a fuel cell with large capacity hydrogen tanks, natural gas, or batteries to power the trailer power pack, without affecting the weight and volume of the road tractor. Furthermore, the other key advantage is the modularity of the design. This provides several configurations on the same platform, such as, for example, a day cab, a living cab, an autonomous vehicle, and the like.

Accordingly, in one embodiment there is provided an autonomous power supply for a vehicle comprising:
a controller;
a rechargeable battery; and
a range extender;
the controller, the rechargeable battery and the range extender being mounted on a vehicle trailer or a truck frame in a self-contained unit, and connected to an electric semi-truck, the range extender being adapted to charge the battery or to supply energy directly to the electric semi-truck or to an EV truck, the controller being in communication with the rechargeable battery and the range extender, the battery being charged to capacity in a default, stationary charging configuration, the battery being continually charged in a dynamic charging configuration.

In one example, the range extender includes one or more power generators. The power generators include an internal combustion engine, a free-piston linear generator, a micro gas turbine, a fuel cell, a zinc-air battery, or a lithium-ion battery.

In one example, the power supply is connected to a refrigeration unit.

In one example, the refrigeration unit is mounted on a trailer body, a truck body, or on a sea shipping container.

In one example, the power supply is connected to a truck driver's cab to supply energy to a heater, air-conditioning, lighting, when the semi-truck or the truck is isolated and not in operation.

In another example, the power supply is connected to an electric heater located in a dry van trailer or an insulated truck body for use in cold climates.

In another example, the power supply is installed on a mixer truck, a fire truck, a garbage truck or a concrete pomp truck.

In another example, the power supply the vehicles include electric power units mounted on a trailer or a truck.

Accordingly in another embodiment, there is provided a self-powered modular refrigeration unit for a vehicle comprising:
a controller;
an inverter;
first and second chargers;
a rechargeable battery;
a range extender; and
electric driven axles;
the controller, the rechargeable battery and the range extender being mounted on a vehicle trailer or truck frame in a self-contained unit, and connected to an electric semi-truck, the range extender being adapted to charge the battery or to supply energy directly to the electric semi-truck or to an electric vehicle (EV) truck, the controller being in communication with the rechargeable battery and the range extender, the battery being charged to capacity in a default, stationary charging configuration, the battery being continually charged in a dynamic charging configuration.

Accordingly, in another embodiment there is provided a trailer with a truck tractor, comprising:
a fuel storage system;
a power pack;
a junction box;
a coolant system;
a current converter;
a current inverter;
an electric motor;
a plurality of connectors; and
a network interconnecting the fuel storage system, the power pack, the junction box, the coolant system, the current converter, the current inverter, the electric motor, and the plurality of connectors, the network being configured such that: i) when the truck is moving in a first direction at a first constant speed, energy flows from the fuel storage system to the junction box and to the electric motor so as to power the truck.

In one example, the network is further configured such that: ii) when the truck is moving uphill at an incline and at an accelerating speed, energy flows simultaneously from the battery pack and the fuel storage system via the junction box to the electric motor as to power the truck.

In another example, the network is further configured such that: iii) when the truck is moving downhill and is decelerating, energy flows from the fuel storage system via the junction box to the battery pack.

In another example, the network is further configured such that: iv) when the truck is decelerating, energy flows from the electric motor to the battery pack via the inverter and the junction box.

In another example, the network is further configured such that: v) when the battery pack is in a low state of charge (SOC), energy from the fuel storage system to the junction box and simultaneously flows to the batter back and the electric motor via the inverter; and vi) when the battery pack is in a high state of charge (SOC), energy flows from the battery pack to the electric motor via the junction box and the inverter.

In yet another example, the fuel storage system includes one or more hydrogen tanks and one or more fuel cell systems, a plurality of pipes and pumps interconnecting the hydrogen tanks and the fuel cells.

In still another example, the battery pack includes cells, sensors, and a battery management system.

In one example, the current converter is a DC/DC converter adapted to convert DV voltage current from the fuel cell and the battery pack to the DC voltage current.

In one example, the current inverter is a DC/AC inverter adapted to convert the DC current from the fuel cell and the battery pack to AC current to supply a refrigeration unit and accessories.

In yet another example, the system further includes a system control unit and a data recorder.

Accordingly, in another embodiment, there is provided a trailer powered electric semi truck comprising:
a non-linear chassis having a front portion which includes a steering axle, the chassis having a first floor and a first upper section disposed above the first floor;
a plurality of electric axles mounted on the first upper section, the first upper section having a wheel connected thereto; and
a modular cabin mounted the first floor of the chassis, the modular cabin includes first, second and third interchangeable sections, the modular cabin being connectable to the chassis.

In one example, the modular cabin includes a front section, a middle section and a rear section.

In one example, the front section adapted to drive the vehicle.

In one example, the middle section includes a mini kitchen, shower, toilet, living room, or sleeping area.

In one example, the front section is a bulkhead.

In one example, a day cab includes a combination of the front section and the rear section.

In another example, a sleeper version includes a combination of the first section, the middle section and the front section.

In yet another example, the cabin is mounted on the first floor of the chassis.

In still another example, the cabin is independent and self-supporting, the steering axle being fixed thereto.

In yet another example, the cabin is directly connected to the chassis using either a fixed system or a removable system.

In yet another example, the first floor is a low ground clearance floor.

In one example, the semi-truck further includes a battery backup.

### BRIEF DESCRIPTION OF THE DRAWINGS

These and other features of that described herein will become more apparent from the following description in which reference is made to the appended drawings wherein:

FIG. 1 is a side view of a refrigeration unit located on a refrigerated semitrailer;

FIG. 2 is a side view of the container-chassis on which a container is located;

FIG. 2A is a stand-alone intermodal container-chassis trailer;

FIG. 3 is a side view of an electric semi-truck;

FIG. 4 is a side view of a refrigeration unit located on a refrigerated straight truck;

FIG. 5 is a side view of EV and non-EV truck, with batteries integrated in the sub-frame and a range extender;

FIG. 5A illustrates a sub-frame for straight truck having a compressed hydrogen and battery version of the Truck Power-Pack;

FIG. 5B illustrates a sub-frame for a straight truck version liquid hydrogen storage version of the Truck Power-Pack;

FIG. 5C illustrates a sub-frame for a straight truck CNG/LNG/RNG version of the Truck Power-Pack;

FIG. 5D illustrates a sub-frame for straight truck full battery version of the Truck Power-Pack;

FIG. 6 is a flow diagram of a long-range power pack;

FIG. 7 is a longitudinal cut through view of an air guide system for 53′ to 60′ long refrigeration boxes and containers;

FIG. 8 is a perspective top view of the system showing a chute and the connection between a rigid clip and a flexible air guide blade;

FIG. 9 is a perspective and longitudinal cut through view of the rigid clip of FIG. 8;

FIG. 10 is a perspective view of the full chute;

FIG. 11 is a cross sectional view of a transparent profile for location under the rigid clip;

FIG. 12 is a close up cross-sectional view of the transparent profile;

FIG. 13 is a close up view of the transparent profile for housing an LED;

FIG. 14 is a longitudinal cut through view and diagrammatic representation of an embodiment of a trailer powered electric semi-truck;

FIG. 15 is a perspective front view of the electric power semi truck;

FIG. 16 is a partial cut away view of the electric semi-truck showing various living spaces;

FIG. 17 is a plan view of the living spaces of FIG. 16;

FIG. 18 is as side perspective view of FIG. 16;

FIG. 18A illustrates a tractor design in three separate configurations (upper, middle and lower);

FIG. 19 is a diagrammatic representation of a power supply chain of the semi-truck of FIG. 15;

FIG. 20 is a schematic representation of a reefer trailer;

FIG. 21 is a schematic representation of a range extender version for an electric tractor;

FIG. 22 illustrates schematic representations of a constant truck speed configuration (upper) and an uphill acceleration configuration (lower);

FIG. 23 illustrates schematic representations of a downhill truck movement configuration (upper) and a controlled deceleration configuration (lower); and

FIG. 24 illustrates a low battery state of charge (SOC) configuration (upper) and a high battery state of charge (SOC) configuration.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

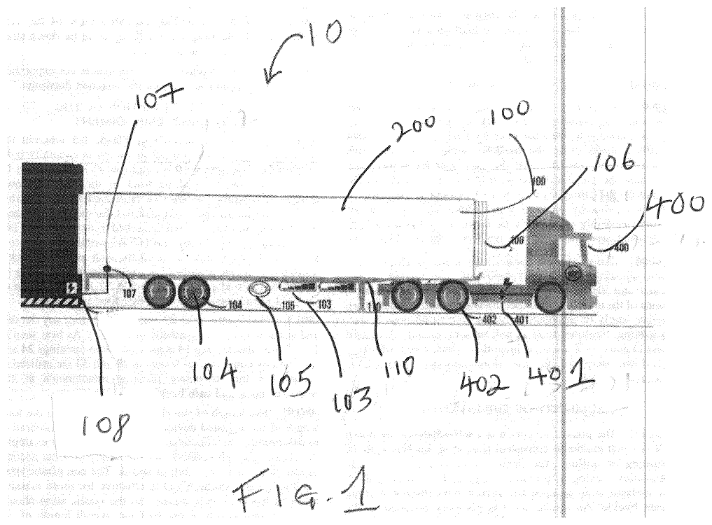

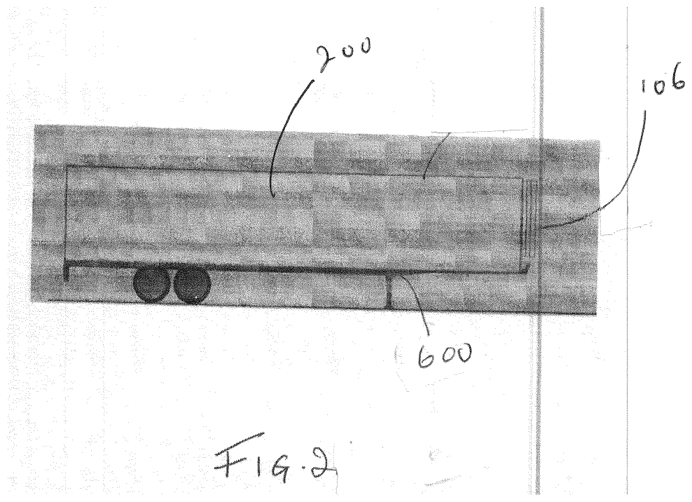

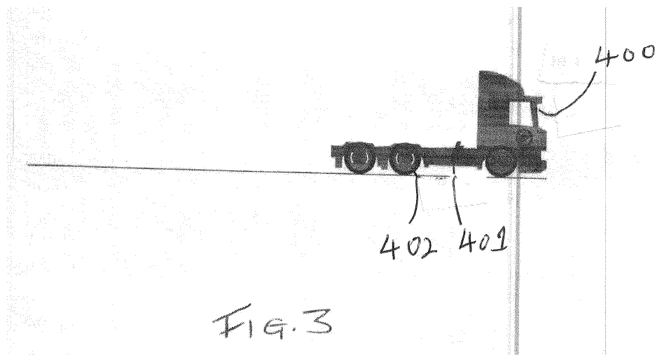

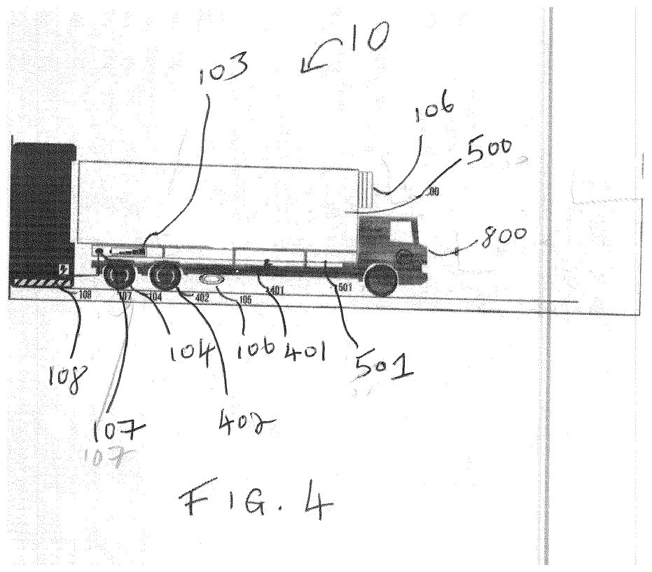

Referring to FIGS. 1 through 5 there is shown generally at 10 a rechargeable battery pack 103 which provides the necessary energy to an electric powered refrigeration unit 106. An additional range extender 105 provides additional power source to extend the autonomy of the batteries on trailers. The range extender 105 also supplies power for an Electric Semi-Truck 401, having a semi- truck driver's cab 400, to extend their range capacity and to recharge their batteries. As specifically seen in FIG. 1, an electric power-train includes respectively trailer's electric axel 104 and semi-truck's electric axel 402 that are connected to the power supply system and the range extender 105, thus creating a complete electric vehicle (EV). A container-chassis trailer or cross member 110, having the battery pack 103 and the range extender 105 connected supply power, supplies the electric power to refrigerate sea freight containers and supplies the Electric Semi-Truck 401, Electric Terminal Tractor. The battery pack 103 can also power 100% electric tractors and a multi-train refrigeration unit trailer set, which has two, three, four or more trailers towed by a single Semi-Truck. A refrigerated straight truck, which includes the range extender 105 for supplying power to a refrigeration unit and also to a 100% electric truck, supplies power and to any instrumentation that requires electrical energy such electric powered hydraulic pump and equipment, driver's cab air-conditioning, heating, lightings, and the like.

When disconnected from the electric semi-truck 401, an intermodal container-chassis trailer 600 includes a shipping container 200 and a refrigeration unit 106 connected thereto.

Broadly speaking, the design includes a modular device that fully integrates these various components for a new kind of application and allows for modification of the energy source of the refrigeration unit and increases its autonomy by using an electric vehicle and range extenders. The range extender 105 can be one of many sources of energy production (or generation). The range extender 105 can be with a gasoline engine or with a CNG turbine or engine, or more desirably, a hydrogen gas fuel cell.

The rechargeable battery pack 103, the range extender 105, and the controller are all in a modular device that is installed either on the semi-trailer 110 or located under the truck body 501. The produced energy by the range extender 105 can be stored in the battery pack 103 so as to feed an Electric Semi-Truck 401, increasing the autonomy of the Electric Semi-Truck 401 or to supply directly of the electric motor of the tractors by range extenders. Examples of range extenders include, but are not limited to, the following: internal combustion engine, free-piston linear generator, micro-gas turbine, fuel cell, zinc-air battery, and lithium-ion battery. Generally speaking, for our applications we find that the fuel cell is more desirable as a range extender or power source.

Advantageously, the improved power supply significantly increases the range of the Electric Semi-Truck 401, and EV trucks, and allow them to extend their travelling range to inter-city and international transport without any recharging stop.

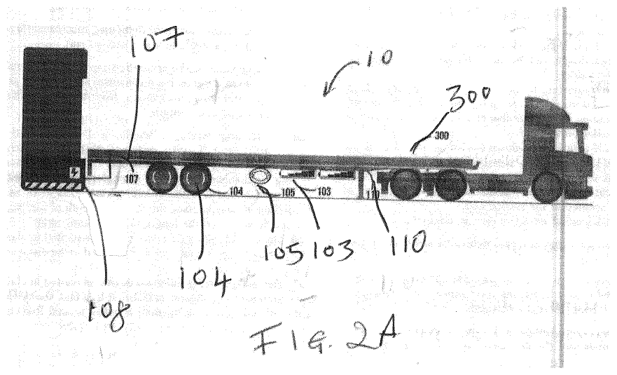

This can also supply energy for trailers that carry refrigerated sea shipping containers 200, 600, as seen in FIG. 2A, or heater for dry vans trailers in cold areas 300, 700, Moreover, the battery pack and range extenders can be used specifically for use for mixer trucks, garbage trucks, fire trucks, concrete pomp trucks, and indeed any type of vehicle that includes electrically powered equipment mounted on trucks or trailers.

The modular aspect of the design allows the various components to produce and store the necessary energies independent of an internal combustion engine by using an electrical refrigeration unit, electrical axles 104 with regenerative braking system to recover the kinetic energy during braking for feeding power to the battery pack 103 not accelerating the truck. In one example, the range extender 105 is a fuel cell using hydrogen gas which is added to provide extended energy to the system. The batteries used herein provide energy to the refrigeration unit and to all electric equipment mounted on the truck, the trailers (multi-refrigeration unit trailers), Truck driver's cab air-conditioning (AC), heater, lighting and indeed any devices or units that operate using electrical power 106.

Turning back to FIGS. 1, 2, 4 and 5, the electric axles 102, 104 are located underneath the sub-frame 501 which includes integrated batteries. In the stationary default configuration, the power systems are connected to a power grid source 108 via an OBC charger 107 or via Direct Current charging. The refrigeration unit 106 is connected to an insulated truck body 200 or 500. The batteries 103 and the range extender 105 are connected to a truck driver's cab 800.

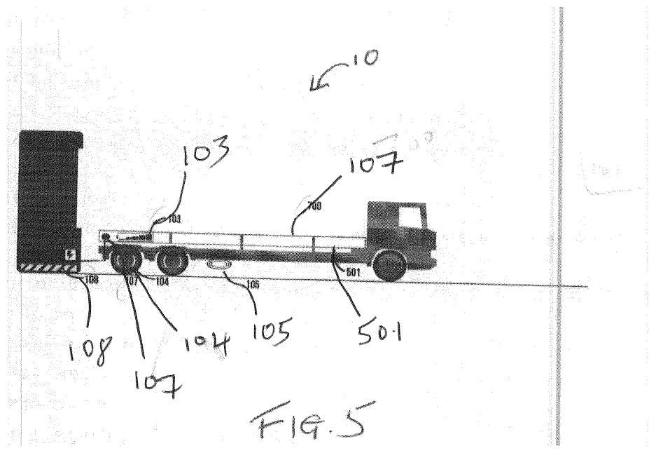

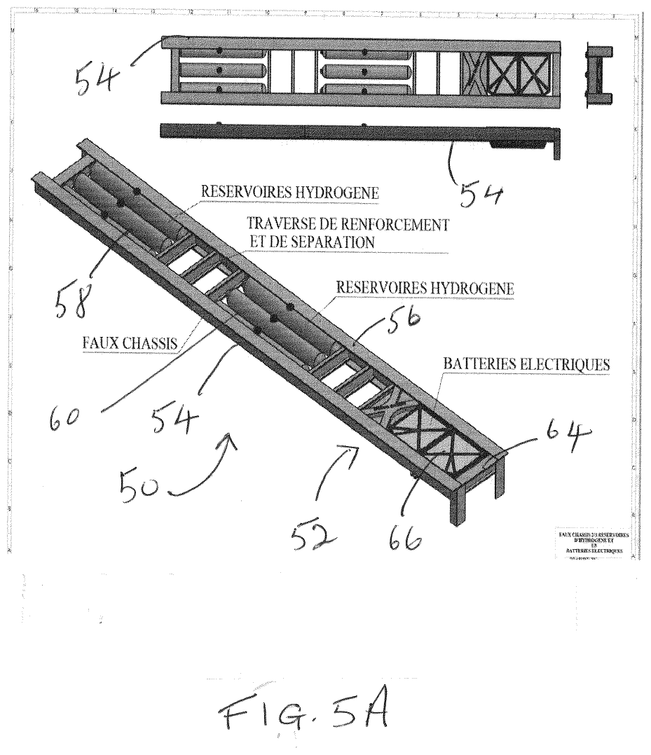

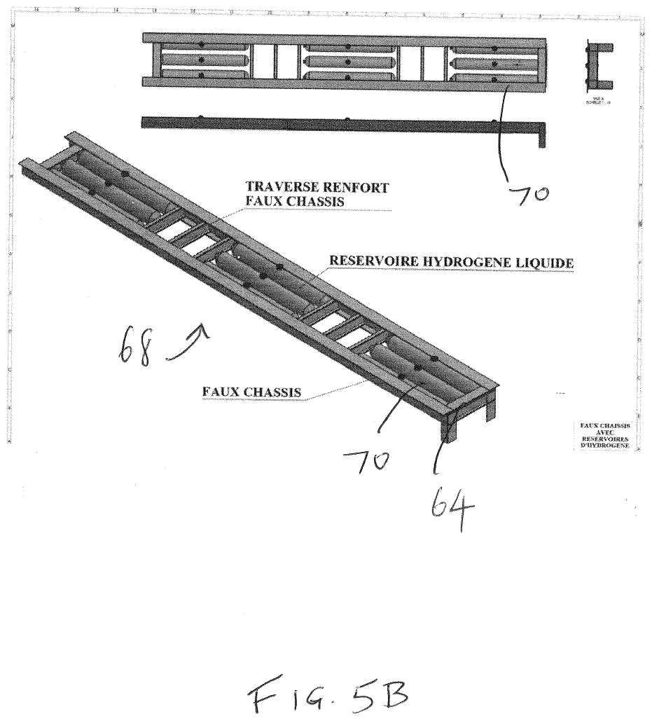

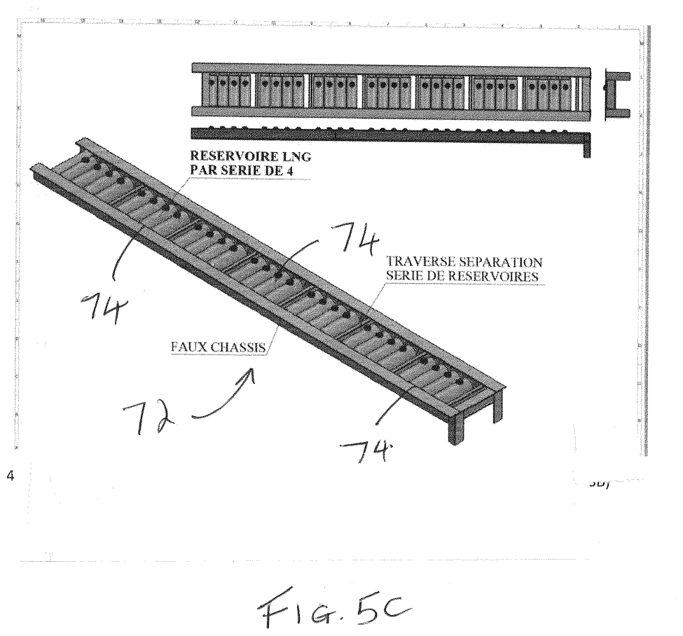

Referring now to FIGS. 5A through 5D, there are illustrated a number of subframes 50 for mounting thereon a truck power pack system 52.

Referring now specifically to FIG. 5A, a first subframe 54 for use with a straight truck includes an elongate, rectangular shaped frame 56 on which are mounted a first plurality of hydrogen reservoirs 58 and a second plurality of hydrogen reservoirs 60, typically in the form of hydrogen cylinders in which are contained compressed hydrogen. In the example shown, in the first plurality of reservoirs 58 there are three cylinders mounted in parallel, and similarly in the second plurality of reservoirs 60 there are an additional three cylinders also mounted in parallel. Located between the first and second plurality of reservoirs 58, 60 is a first transverse reinforcement set of walls 62 which help to stabilize the subframe 54. Located at a front end 64 of the subframe 54 are a block of batteries (a battery pack) 66. A second transverse reinforcement set of walls 68 is located between the second plurality of reservoirs 60 and the batteries 66.

Referring now to FIG. 5B, a second subframe 68 for use with a straight truck is essentially identical to the first subframe 54. In the second subframe 68, there are mounted on the rectangular shaped frame, a third plurality of hydrogen reserves 70. The third plurality of hydrogen reserves 70 are located at the front end 64 of the subframe 68 in place of the block of batteries 66.

Referring now to FIG. 5C, a third subframe 72 for use with a straight truck, deviates in design from the first and second subframes described above. The third subframe 72 includes an identical elongate, rectangular shaped frame 56, but in this design a plurality of LNG, CNG or RNG reserves 74 are mounted in parallel along substantially the entire length of frame 56. Each reserve 74 is separated using a wall located therebetween. Advantageously, the reserves 74 provide an efficient use of the frame 56 area and permit packing of multiple energy sources therein.

Referring now to FIG. 5D, a fourth subframe 76 for use with a straight truck is similar to the third subframe 72 in that a plurality of battery packs 78 are mounted therein.

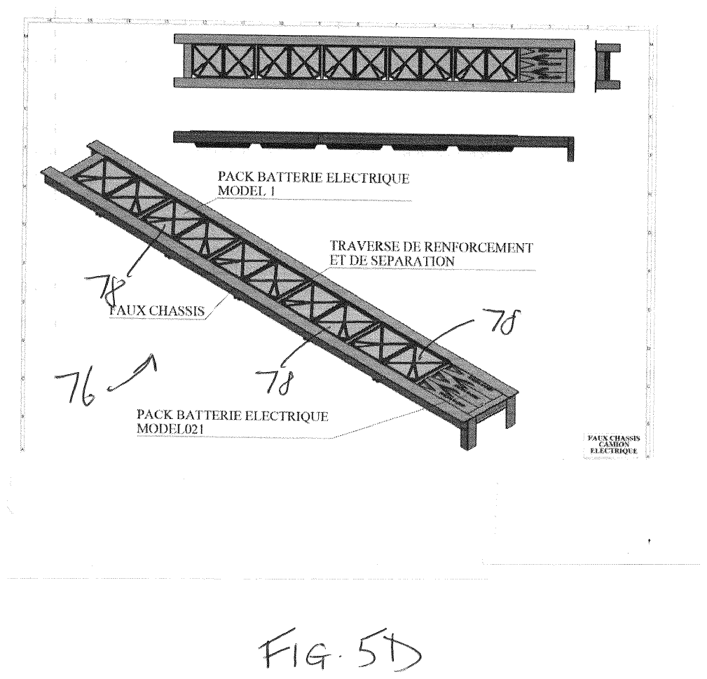

Referring now specifically to FIG. 6, a general method of charging a power pack 103 and use thereof is shown by way of a block diagram, Initially, the pack 103 is connected to a grid power source 10 via an On Board Charger (OBC) 12, which in turn is connected to the battery pack 103. An inverter 16 interconnects the battery pack 103 with a controller 18 so as to control connectivity to Electric Semi-Truck, Electric Terminal tractor, and EV truck, at block 20. Furthermore, the inverter 16 and the controller 18 interconnect with all electrically powered equipment, at block 22, on the trailers and the Electric Semi-Truck, such as refrigeration units, single trailer; multiple refrigerated trailers; tailgate; hydraulic systems; AC, heater and all driver's cabin electric equipment's. A charger MPPT 14 interconnects, at block 24, the power and range extender from fuel cell; gasoline engine, natural gas; and other sources of energy generated.

Thus, in summary, the controller 18, the rechargeable battery 103 and the range extender 105 are mounted on a vehicle trailer frame in a self-contained unit, and connected to a vehicle tractor as complete power train, trailers with electric axels 12, 14 and the Electric Semi-Truck's power train. The range extender 105 is adapted to charge the battery 103 when the controller 18, which is in communication with the rechargeable battery 103, charges the battery to full capacity in a default, stationary charging configuration, such as when connected to the grid power source 10, and thereafter, once disconnected from the grid power source 10, the battery is then continually and autonomously charged in a dynamic charging configuration when the vehicle is moving.

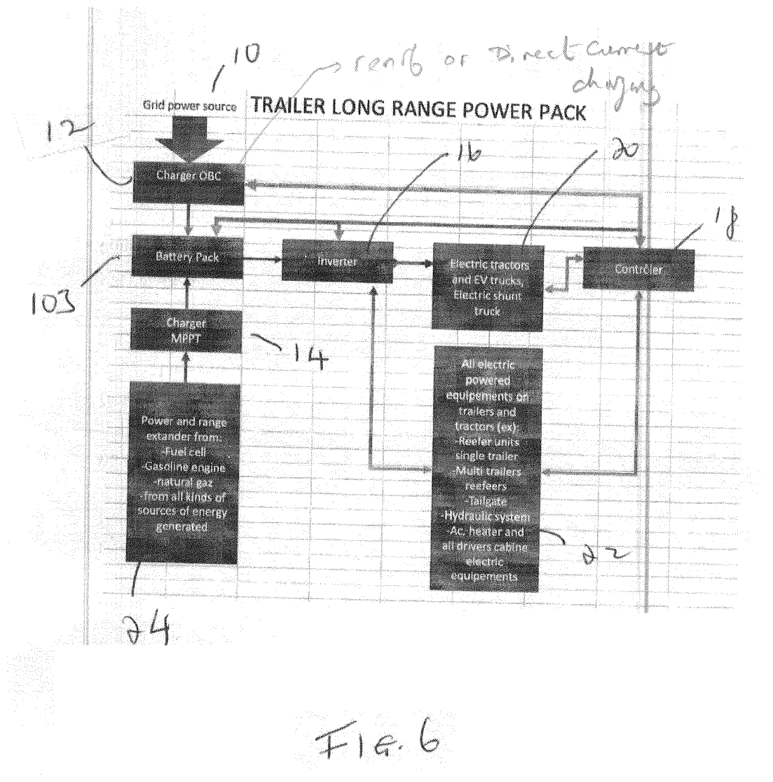

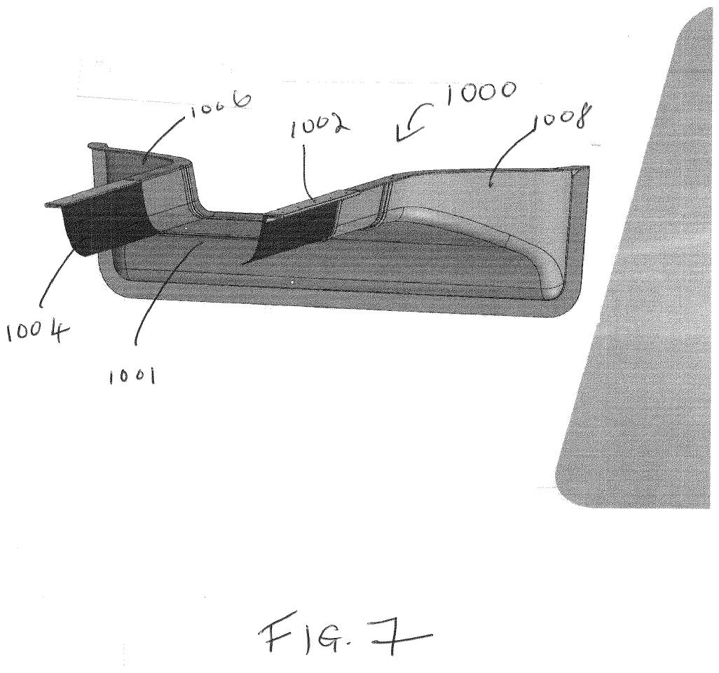

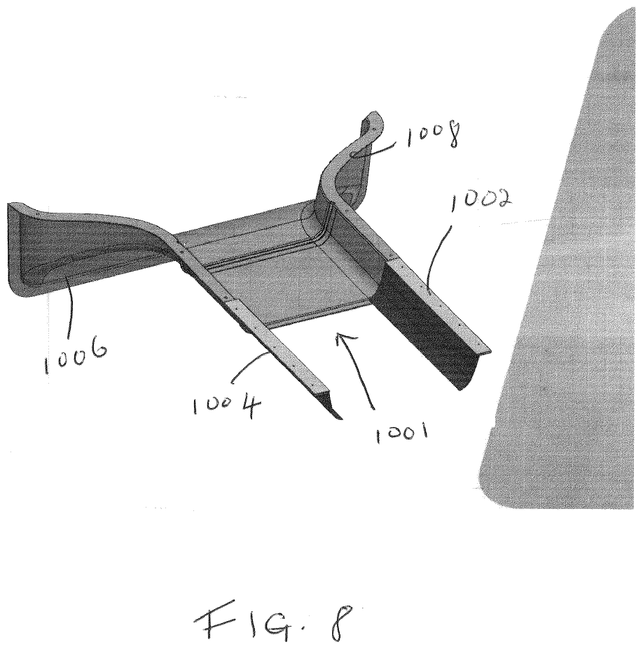

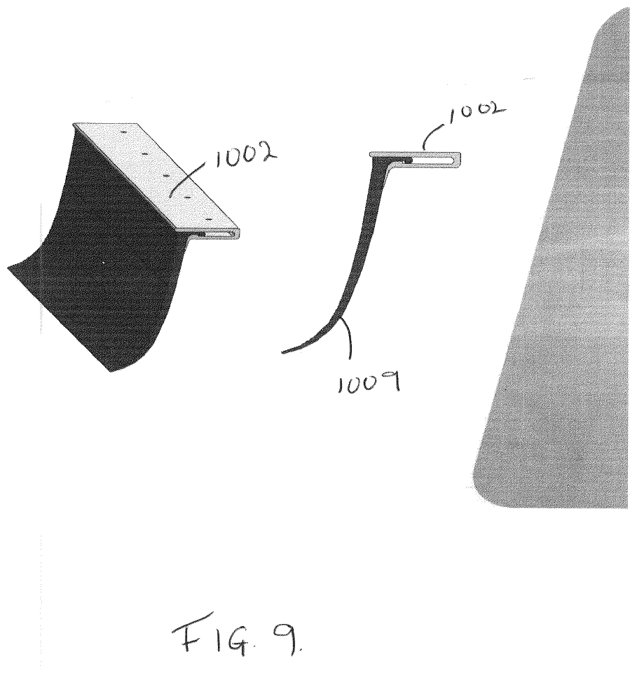

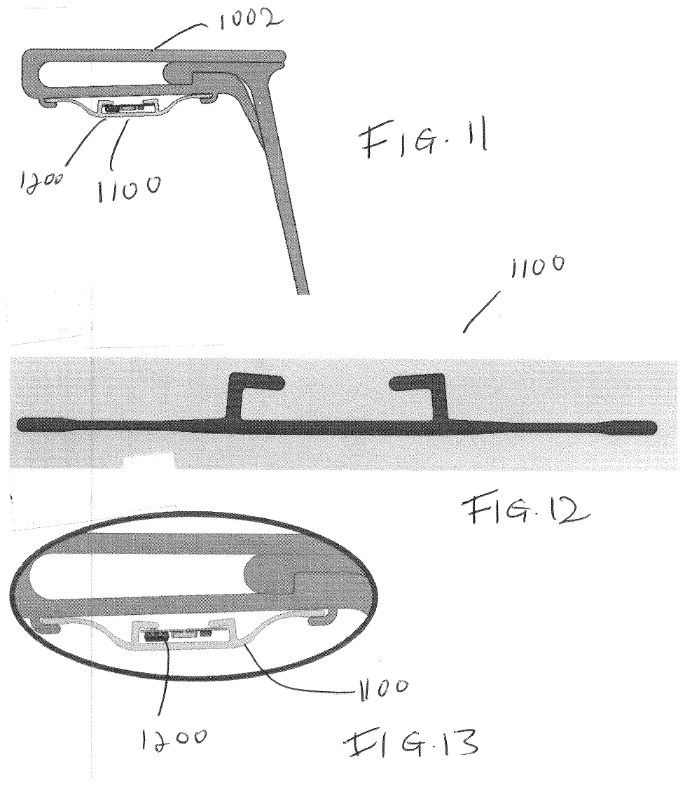

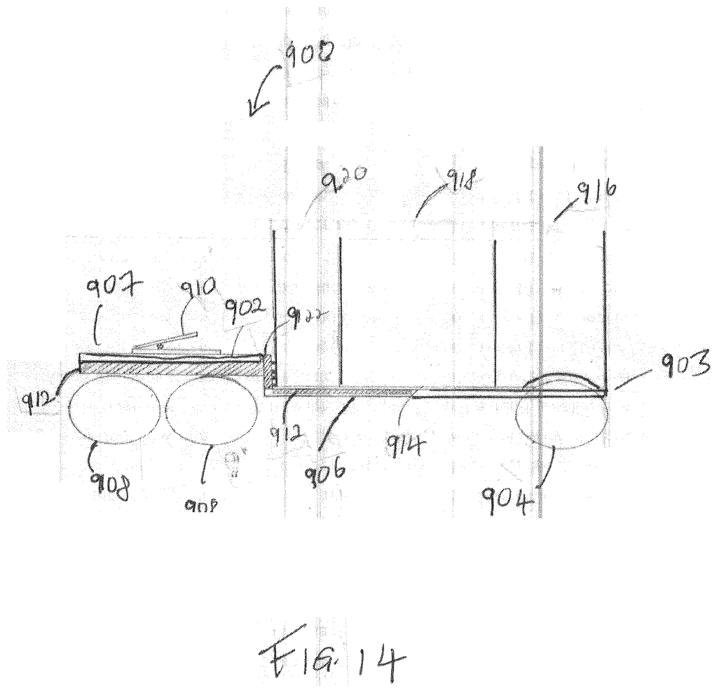

Referring to FIGS. 7 to 13, an air guide system 1000 is used for unbreakable refrigerated transportation of goods and can be installed easily and requires little maintenance.

The air guide system 1000 allows a homogeneous distribution of air in 53′, 60′ reefer trailers and containers, while being flexible and resistant to shocks during loading and unloading operations. The air guide system 1000 includes a rigid air manifold part 1001, two unbreakable flexible guides 1002, 1004, and two self-locking rigid guide supports 1006, 1008. The system 1000 includes a flexible blade 1009 connected to each of the flexible guides 1002, 1004 and is curved inwardly towards the rigid air manifold 1001. In use, the system 1000 guides cold air into the refrigerated trailer without breaking during loading operations. The chute is easy to install and repair, is impact resistant, and if damaged, only the damaged section is replaced. The system 1000 has been successfully tested for the 53′ trailers for the first time, showing that our system allows the cold to circulate throughout the entire refrigerated volume and demonstrates the case of quick and novel installation. Furthermore, the chute 1000 advantageously improves upon an Internal Flow Optimizer (IFO). The IFO includes i) an optimized shape universal air funnel which compresses and accelerates airflow from an evaporator; ii) a central channel which push the flow immediately; iii) an open flexible air guide system that moves this flow with minimum pressure to the rear of the box; and iv) extremely rapid and efficient to bring down the temperature in the box. A nozzle is designed to collect and accelerate the airflow

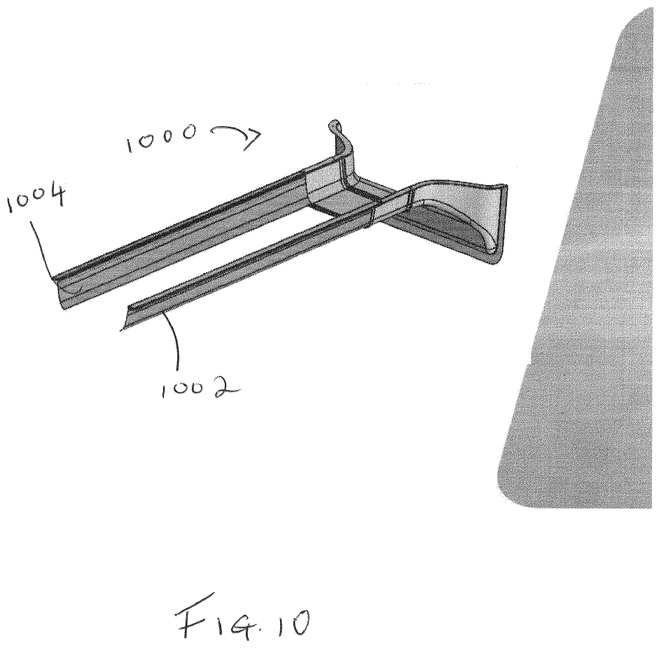

Referring specifically to FIGS. 11, 12 and 13, there is illustrated an LED light air chute option. A transparent profile 1100 can be inserted under the clip on the whole length of the chute or a part thereof. A strip of LED lights 1200 can be located between the profile 1100 and the flexible guides 1002,1004.

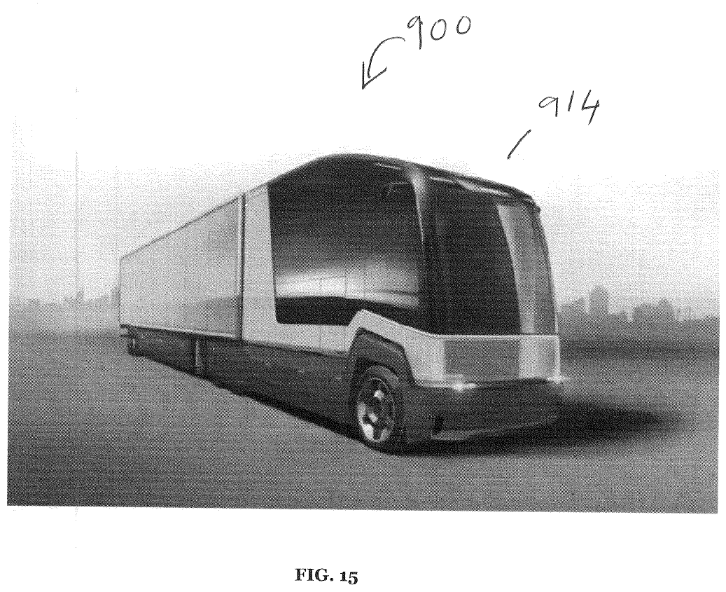

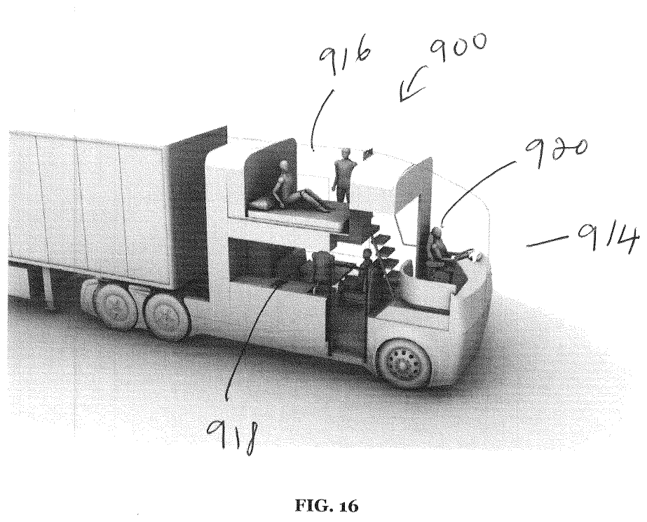

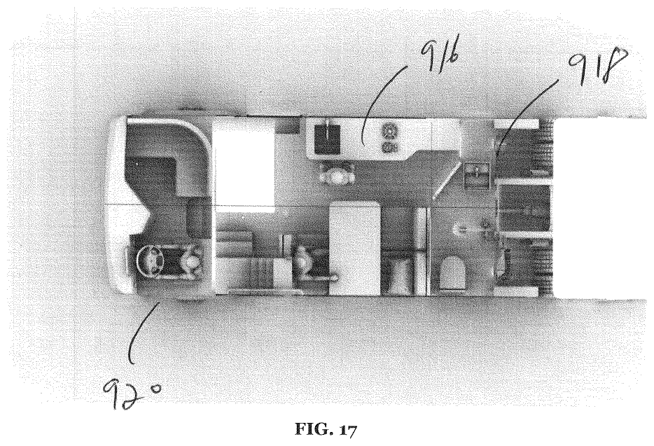

Referring now to FIGS. 14 through 18, an electric road tractor 900 is generally illustrated which is configured to avoid being affected by power density. This is well known to be a major problem for any road tractor manufacturer in order to offer electric tractors for long distances, which require a lot of space for the batteries or hydrogenated tanks, which cannot at the same time offer spacious cabins for the drivers and at the same time have sufficient autonomy to cover long distances. The electric road tractor 900 includes the main power system located on the trailer, which allows a new modular configuration of the vehicle. The tractor 900 includes a non-linear chassis 902 with a front part 903 that includes a steering axle 904 which has a low ground clearance floor 906. A plurality of electric axle(s) 908 are mounted on a high section 907 of the chassis 902 which includes a fifth wheel 910, a battery backup 912, for yard use only, may be installed on the section 902 of the chassis or in the low ground clearance floor 906. A cabin 914 is installed on the low ground clearance floor 906 of the chassis 902. Advantageously, the cabin 914 is modular and includes three interchangeable sections 916, 918, 920. The front section 920 is used for driving the vehicle, the middle section 918 includes a mini kitchen, shower, toilet, living room, sleeping area. Furthermore, the front section 920 is the bulkhead section. It is possible to combine the rear section 916 and the front section 920 to create a day-cab version for short distance use. A sleeper version can be created by combining all three sections 916, 918, and 920. The cabin 914 is independent of the chassis 902. The cabin 914 can be mounted the low ground clearance floor 906 or it can be independent and self-supporting on which the directional steering axle 904 can be directly fixed, and the low ground clearance floor 906 of the chassis can be remove. The cabin 914 is directly connected to the chassis 902 using either a fixed or removable system 922 so that the cabin 914 can be easily detached therefrom. In the case of a configuration of an autonomous vehicle, the chassis 902 and the steering axles 908 will be directional and will provide full electrical power to the semi-trailer(s) of an autonomous vehicle.

Broadly speaking, the dimensions of the system are as follows. The system has a ground clearance of 350 mm minimum. No parts hang below this level. Consequently, the system height is lower than 630 mm. In our designs, we ensure that the system width (lateral dimension) is generally at 2450 mm in order to have an external aerodynamics effect replacing lateral fairings of the trailer. In the event the system width is lower than 2450 mm, we would design sufficient space to add lateral fairings to the trailer. The system's longitudinal dimension is lower than 7930 mm in order to be located between the trailer rear axle and the front stands. Furthermore, to continuously monitor system performance, a recorder is included that will store performance data for a duration of 60 days. The data includes the system's main states and activities with a sample rate of one acquisition per minute. The recorder monitors and stores information that includes i) external temperature; ii) internal temperature; iii) tractor instant power consumption (voltage, amps); iv) reefer instant power consumption (voltage, amps); v) tank pressure; vi) fuel cell output power (voltage, amps); vii) battery state of charge; viii) cumulated energy throughout battery (in and out); ix) dock plugin state (plugged in); and x) dock plugin power supply (voltage, amps). Advantageously, the components are accessible to permit easy and quick servicing and maintenance. This reduces the need to remove or dismount major components.

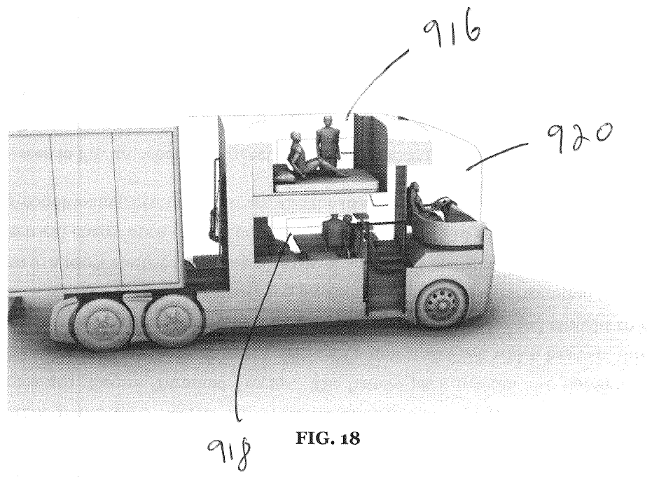

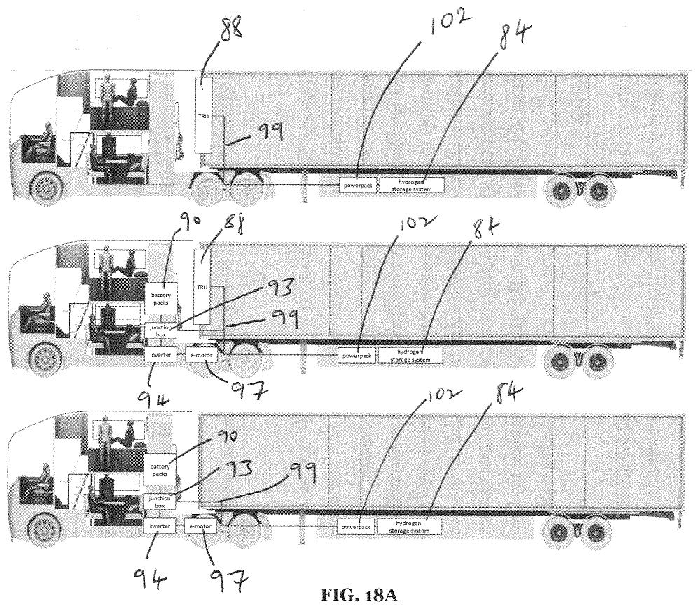

As best illustrated in FIG. 18A, there are three novel and unobvious different tractor configurations. A first configuration (the upper diagram) includes a trailer refrigeration unit (TRU) 88 connected to a powerpack 102, which in turn is connected to a hydrogen storage 84. A second configuration (the middle diagram) includes the hydrogen storage 84 connected to the powerpack 102, which in turn is connected to the TRU 88. The junction box 93 is connected to a battery pack 90, a converter 94 and an electric (e)-motor 97. Finally, a third configuration (the lower diagram), the TRU is absent. In the third configuration, the hydrogen storage 84 is connected to the powerpack 102, which in turn is connected to the junction box 93, the battery pack 90, the converter 94 and the electric (e)-motor 97. A person skilled in the art will readily recognize that although the terms “hydrogen storage system” or “hydrogen storage” are used throughout by way of example, it is contemplated that any energy storage system or range extender can be used with equal overall effect.

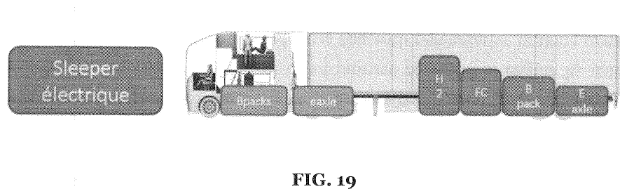

Referring to FIG. 19, a schematic representation of the electric road tractor 900 is shown in which the power supply system is shown in series.

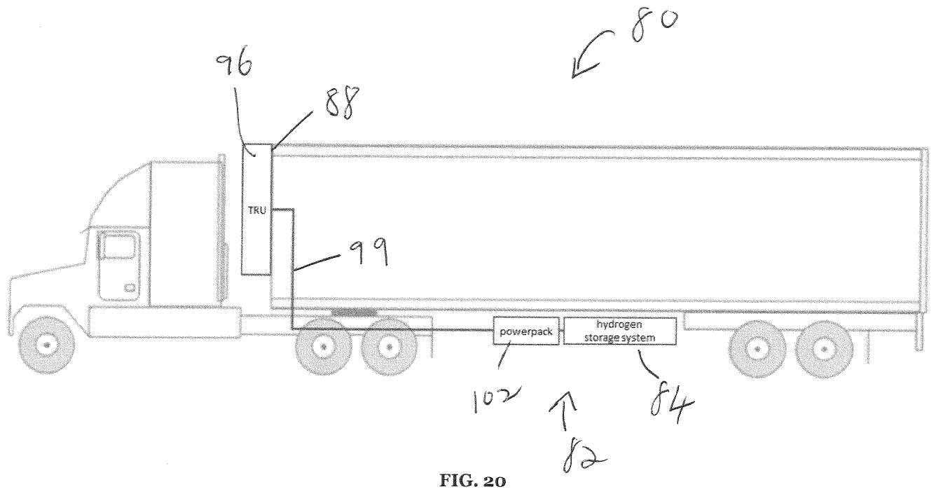

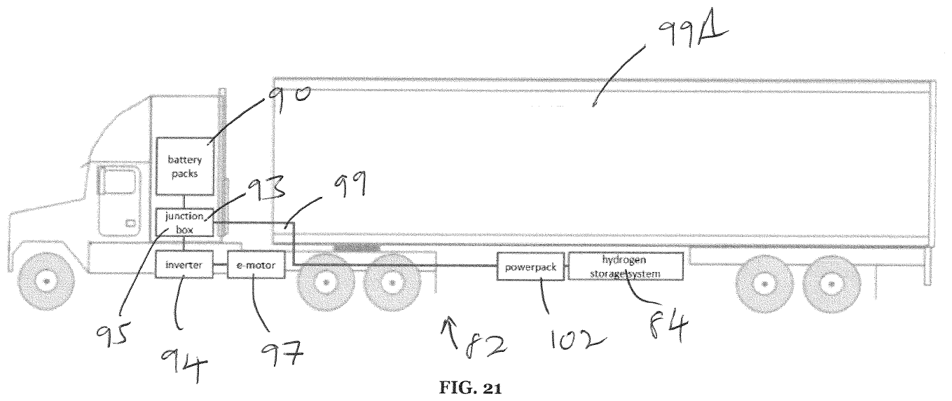

Referring now specifically to FIGS. 20, a reefer powerpack version (for reefer trailer) 200 is illustrated in which a trailer refrigeration unit (TRU) 88 is located adjacent the cabin rear. The TRU 88 is interconnected and in communication with the power pack and the hydrogen storage 84. Referring now to FIG. 21, a range extender version for an electric tractor in which the power pack 102 and the hydrogen storage 84 is interconnected and in communication, in series, with the junction box 93. The junction box 93 is connected to the battery pack 90, a converter 95 and an e motor 97.

In one system embodiment, which is designed for use with a short trailer, the energy supply network 82 includes the hydrogen storage system 84, which includes storage tanks, valves and conduits (pipes) 99 to transfer the hydrogen and a fuel cell system that includes a balance of plant together with accessories. Also included is a cooling system 88, which includes an amount of a coolant material together with conduits (pipes), pumps, radiator, fan. A battery pack 90 includes fuel cells, sensors, and a battery management system. A junction box 93 is located between the battery pack 90 and the inverter 94, which in turn is connected to an electric motor 97. Located in electrical communication with the battery pack 90 is a DC/DC converter 95 which is used to convert the DC voltage current from the fuel cell and the battery pack 90 to the DC voltage current needed to supply the tractor, and the DC/AC inverter 94 to convert the DC current from the fuel cell and battery pack 90 to AC current needed to supply a refrigeration unit 96 and accessories. Also includes is a control unit and a data recorder. The components of the energy supply network 82 are interconnected and in communication so as to provide energy management as will be described below. The long trailer 99A includes all the components from the short trailer system, but includes another module having the tanks, pipes and valves needed to allow for complete autonomy.

Generally speaking, the functions of the hydrogen storage system functions to be compliant with safety standards. The hydrogen tanks are refueled with compressed or liquid hydrogen. The fuel cell component functions to convert hydrogen into electricity at the best energy efficiency. The cooling system helps to dissipates the thermal energy in the form of heat which comes from the fuel cell and maintains the input coolant temperature below the fuel cell requirements. The radiator of the cooling system is located so as to minimize the exposure to the projections from the tractors wheels and to reduce the risk of clogging. The battery pack allows the dynamic response of the system in all the different states of the fuel cell. To avoid switching off the fuel cell (which if done too frequently could have an impact on its durability), the fuel cell might be producing power, even at idle, that could be higher than the reefer needs. In that case the energy needs to be stored in the battery pack. The energy is released to the reefer once needed and in accordance with the fuel cell power generation. The battery pack is managed to deliver the correct amount of energy that is not delivered by the fuel cell due to lack of dynamic response or to intentional management. The state of charge of the battery pack is maintained in the proper range for safety and functional reasons.

The system is designed so that the electric tractor will have sufficient range to operate as it moves between warehouses without a trailer powerpack. Also, the electric tractor includes a deceleration energy recovery system. This is also known as “regenerative braking”. Given that the tractor and trailer operate independently, they each have their own independent cooling system. The electrical architecture of the system includes a high voltage network located on the vehicle, which can be either about 400V or about 800V. Considering the amount of power and energy needed to provide the right range extension, the system will be adapted to a long trailer definition (48 to 53 ft).

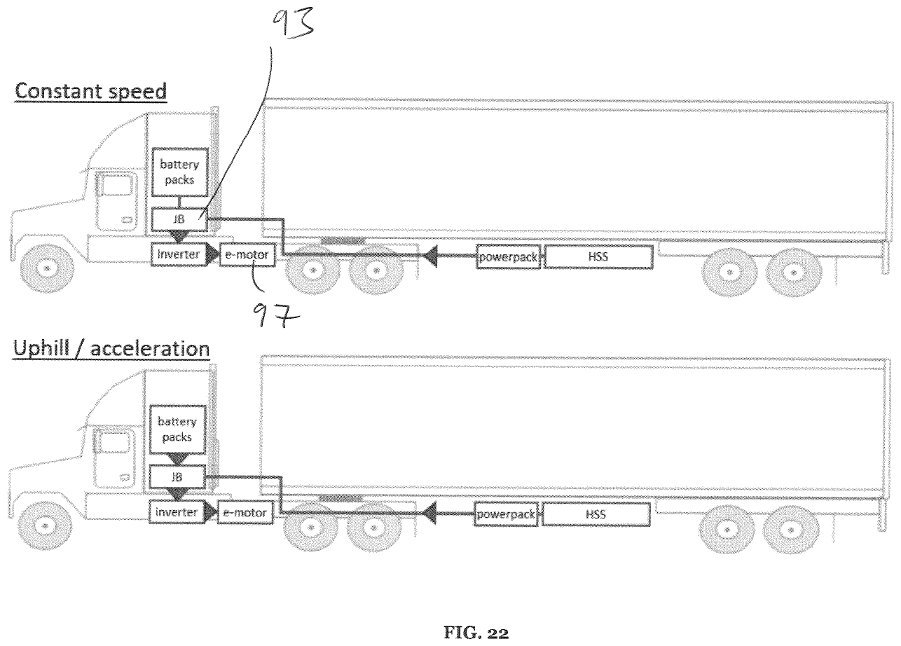

Referring more specifically to FIGS. 22 through 24, the energy systems and their functions will now be described in detail, and is illustrated by way of arrows. Located under the chassis is a hydrogen storage system, a powerpack, battery packs, a junction box, an inverter and an e-motor.

Referring to FIGS. 22 through 24, there is illustrated is illustrated a tractor in various states of motion. In FIG. 22, when the truck is moving at a constant speed, energy flow is indicated by the arrows. Specifically, energy flows from the power pack to the junction box and then to the converter and then to the e-motor. When the truck is moving up a hill and moving against gravity, more energy is needed and so energy from the powerpack flows to the junction box, while simultaneously energy travels from the battery pack to the junction box and thereafter to the converter and the electric e-motor 109.

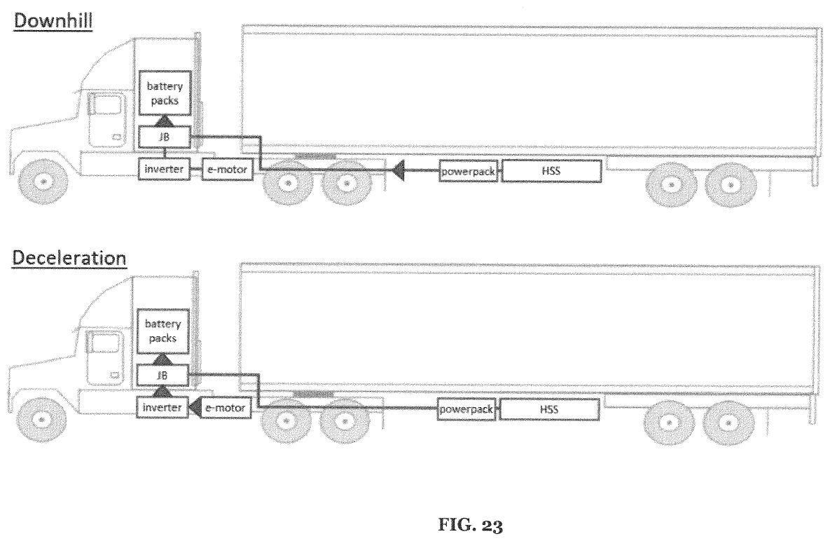

Referring to FIG. 23, when the truck is moving downhill, and its motion is assisted by gravity, energy is transferred form the powerpack to the junction box and then to the battery pack for storage. In an active deceleration, such as during braking, energy flows directly from the e-motor to the converter 108 into the junction box 106 and then into the battery pack for storage.

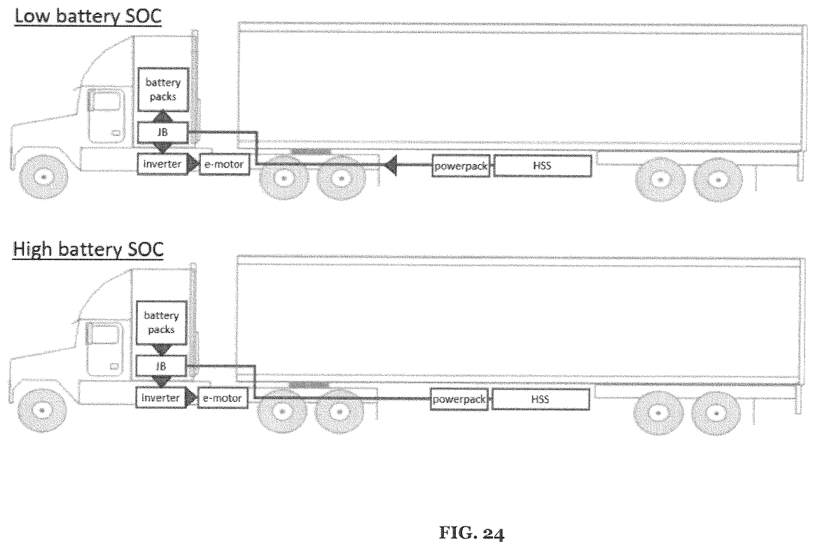

Referring now to FIG. 24, there may be situations in which there is a low battery state of charge (SOC) or a high battery SOC. In a situation in which there is a low battery SOC, the junction box diverts energy it receives from the power pack into the battery pack and the converter 108, which then communicates the energy to the e-motor. Conversely, with a high battery SOC, energy flows from the battery pack 104 only into the junction box and thereafter into the e-motor and the converter.

As a range extender, the system provides a constant energy supply to the tractor, at the best energy efficiency setpoint, to prevent the state of charge of the battery to either exceed a maximum value (over which the battery would not accept any more energy during regenerative braking) or go under a minimal value (under which the vehicle would miss energy for its powertrain). The voltage delivered to the tractor is adapted to the high voltage network of the truck (from 350 V to 800 V). The energy is supplied through correctly sized electric cables. A plug/inlet interface can be used to quickly hook/unhook the trailer from the tractor, such as for example, the CCS1 interface used in a DC charger. The tractor is equipped with a receptacle/inlet located at the back of the cab so as to allow the energy to flow into its battery packs.

The power delivered to the tractor generally will not exceed what can be consumed by the motor or what can be stored in the battery packs. Especially, in the event of a regenerative braking, considering the battery pack will store all the power generated by the motor, it might not be able to store more power coming from the range extender that therefore should quickly decrease its power generation to the minimum level. The power delivered by the range extender is controlled according to specific requests from the vehicle systems in order to prevent failure generation or false failure detection.

### Other Embodiments

From the foregoing description, it will be apparent to one of ordinary skill in the art that variations and modifications may be made to the embodiments described herein to adapt it to various usages and conditions.

What is claimed is:

1. An autonomous power supply for a vehicle comprising:
a controller;
a rechargeable battery; and
a range extender;
the controller, the rechargeable battery and the range extender being mounted on a vehicle trailer or a truck frame in a self-contained unit, and connected to an electric semi-truck, the range extender being adapted to charge the battery or to supply energy directly to the electric semi-truck or to an EV truck, the controller being in communication with the rechargeable battery and the range extender, the battery being charged to capacity in a default, stationary charging configuration, the battery being continually charged in a dynamic charging configuration.

2. The power supply, according to claim 1, in which the range extender includes one or more power generators.

3. The power supply, according to claim 2, in which the power generators include an internal combustion engine, a free-piston linear generator, a micro gas turbine, a fuel cell, a zinc-air battery, or a lithium-ion battery.

4. The power supply, according to claim 1, in which the power supply is connected to a refrigeration unit.

5. The power supply, according to claim 1, in which the refrigeration unit is mounted on a trailer body, a truck body on a rail or a sea shipping container.

6. The power supply, according to claim 1, is connected to a truck driver's cab to supply energy to a heater, air-conditioning, lighting, when the semi-truck or the truck is stationary in a stopped or parked configuration.

7. The power supply, according to claim 1, is connected to an electric heater located in a dry van trailer or an insulated truck body for use in cold climates.

8. The power supply, according to claim 1, is installed on a mixer truck, a fire truck, a garbage truck or a concrete pomp truck.

9. The power supply, according to claim 1, in which the vehicles include electric power units mounted on a trailer or a truck.

10. A self-powered modular refrigeration unit for a vehicle comprising:
a controller;
an inverter;
first and second chargers;
a rechargeable battery;
a range extender; and
electric driven axles;
the controller, the rechargeable battery and the range extender being mounted on a vehicle trailer or truck frame in a self-contained unit, and connected to an electric semi-truck, the range extender being adapted to charge the battery or to supply energy directly to the electric semi-truck or to an electric vehicle (EV) truck, the controller being in communication with the electric driven axles, the rechargeable battery and the range extender and the electric truck, the battery being charged to capacity in a default, stationary charging configuration, the battery being continually charged in a dynamic charging configuration.

11. A trailer with a truck tractor, comprising:
a fuel storage system;
a power pack;
a junction box;
a coolant system;
a current converter;
a current inverter;
an electric motor;
a plurality of connectors; and
a network interconnecting the fuel storage system, the power pack, the junction box, the coolant system, the current converter. the current inverter, the electric motor, and the plurality of connectors, the network being configured such that:
i) when the truck is moving in a first direction at a first constant speed, energy flows from the fuel storage system to the junction box and to the electric motor so as to power the truck.

12. The trailer, according to claim 11, in which the network is further configured such that:
ii) when the truck is moving uphill at an incline and at an accelerating speed, energy flows simultaneously from the battery pack and the fuel storage system via the junction box to the electric motor as to power the truck.

13. The trailer, according to claim 11, in which the network is further configured such that:
iii) when the truck is moving downhill and is decelerating, energy flows from the fuel storage system via the junction box to the battery pack.

14. The trailer, according to claim 11, in which the network is further configured such that:
iv) when the truck is decelerating, energy flows from the electric motor to the battery pack via the inverter and the junction box.

15. The trailer, according to claim 11, in which the network is further configured such that:
v) When the battery pack is in a low state of charge (SOC), energy from the fuel storage system to the junction box and simultaneously flows to the batter back and the electric motor via the inverter; and
vi) When the battery pack is in a high state of charge (SOC), energy flows from the battery pack to the electric motor via the junction box and the inverter.

16. The trailer, according to claim 11, in which the fuel storage system includes one or more hydrogen tanks and one or more fuel cell systems, a plurality of pipes and pumps interconnecting the hydrogen tanks and the fuel cells.

17. The trailer, according to claim 11, in which the battery pack includes cells, sensors, and a battery management system.

18. The trailer, according to claim 16, in which the current converter is a DC/DC converter adapted to convert DV voltage current from the fuel cell and the battery pack to the DC voltage current.

19. The trailer, according to claim 16, in which the current inverter is a DC/AC inverter adapted to convert the DC current from the fuel cell and the battery pack to AC current to supply a refrigeration unit and accessories.

20. The trailer, according to claim 11, further includes a system control unit and a data recorder.

21. A trailer powered electric semi truck comprising:
a non-linear chassis having a front portion which includes a steering axle, the chassis having a first floor and a first upper section disposed above the first floor;
a plurality of electric axles mounted on the first upper section, the first upper section having a wheel connected thereto; and
a modular cabin mounted the first floor of the chassis, the modular cabin includes first, second and third interchangeable sections, the modular cabin being connectable to the chassis.

22. The semi-truck, according to claim 21, in which the modular cabin includes a front section, a middle section and a rear section.

23. The semi-truck, according to claim 22, in which the front section adapted to drive the vehicle.

24. The semi-truck, according to claim 22, in which the middle section includes a mini kitchen, shower, toilet, living room, or sleeping area.

25. The semi-truck, according to claim 22, in which the front section is a bulkhead.

26. The semi-truck, according to claim 22, in which a day cab includes a combination of the front section and the rear section.

27. The semi-truck, according to claim 22, in which a sleeper version includes a combination of the first section, the middle section and the front section.

28. The semi-truck, according to claim 21, in which the cabin is mounted on the first floor of the chassis.

29. The semi-truck, according to claim 21, in which the cabin is independent and self-supporting, the steering axle being fixed thereto

30. The semi-truck, according to claim 21, in which the cabin is directly connected to the chassis using either a fixed system or a removable system.

31. The semi-truck, according to claim 21, in which the first floor is a low ground clearance floor.

32. The semi-truck, according to claim 21, further includes a battery backup.
